(19) United States
(12) Patent Application Publication
(10) Pub. No.: US 2019/0200515 A1
(43) Pub. Date: Jul. 4, 2019

(54) PORTABLE, MULTI-DISPENSING LIQUID CONTAINER SYSTEM

(71) Applicants: Jason Howard Lichtman, Littleton, CO (US); Kristopher Michael Palmer, Lakewood, CO (US); David Lawrence Hyman, Orlando, FL (US); Lance New Harmon, Pasadena, CA (US); Donald Erickson, Saratoga, CA (US)

(72) Inventors: Jason Howard Lichtman, Littleton, CO (US); Kristopher Michael Palmer, Lakewood, CO (US); David Lawrence Hyman, Orlando, FL (US); Lance New Harmon, Pasadena, CA (US); Donald Erickson, Saratoga, CA (US)

(21) Appl. No.: 15/861,830

(22) Filed: Jan. 4, 2018

(51) Int. Cl. A01C 15/02; A01C 23/00

(52) U.S. Cl. CPC A01C 15/02; A01C 23/007

(57) ABSTRACT

An integral multi-dispenser liquid container includes a plurality of hand pump dispensers positioned linearly, triangularly or squarely above a lower container compartment having a centrally-located liquid fill port. A central portion of the lower compartment is removed to cause residual liquid to pool at the suction tubes of the hand-pumps. One or more reinforced grip handles span between the hand-pump dispensers above the lower compartment. The hand-pumps can dispense different liquid volumes as needed in the field and do not need to be removed to refill the container. An internal baffle can be installed within the inside the lower compartment so that different liquids can be carried and dispensed.

### CROSS-REFERENCE TO RELATED APPLICATIONS

None.

### FIELD OF INVENTION

This invention generally relates to portable liquid containers for the repetitive dispensing of measured quantities of the liquid. More specifically, this invention relates to liquid dispensing tools used in the agricultural and horticultural professions to deliver various fertilizers, pH neutralizers, and other liquid solutions to plants and soils. Consistent delivery of liquid quantities to similar plants growing in common soils is often critical to maintaining an even growth distribution and supporting the general health of the plant crop.

### BACKGROUND OF THE INVENTION

In the fields of agriculture and horticulture, where a variety of plant species are grown for the purposes of commercial harvesting or distribution, significant human time and effort must be given to the plant crop to maximize the crop's value. Variations in plant seed stock, localized environmental conditions, external stresses and soil and sunlight conditions can cause some plants to outpace the growth of others, resulting in a lower harvest volume or harvest quality. To maximize harvest volume and quality of a given commercial crop, various fertilizers and other soil additives can be administered individually to certain plants to boost their growth rates and improve their general health conditions.

For example, one common method of tending to a crop showing noticeable variability in growth rate of individual plants is to adjust the pH of the soil around certain plants to a level most optimum for the plant's growth rate or harvest yield. Especially over relatively large plots, soil pH can vary naturally in specific areas of soils over time. Liquid solutions of dilute acids or bases can gradually lower or raise the soil's pH when dispensed into the root area at the base of a plant. This pH adjustment must often be made gradually so as not to cause any adverse stress on the plant. Sometimes, this soil pH correction regimen might require daily additions of specific aliquot of a dilute acid or base to specific plants showing signs of soil pH stress. For larger commercial growing operations, what is needed in the art is a portable liquid container that can rapidly dispensing a controlled volume of a liquid at a given point in the soil around an individual plant.

The hand-actuated, spring-return vertical press-pump dispenser, or “hand-pump,” is a well-known device for rapidly dispensing a controlled quantity of a liquid from a container. These devices are commonly comprised of a suction tube that extends on one end into the liquid container, a dispensing nozzle on the other end from which the liquid is discharged, and a plunger mechanism in between that draws liquid from the container and discharges it out of the nozzle as the user presses down on a pad-space near the discharge nozzle end. The liquid volume discharged is generally proportional to the travel length of the plunger. An internal spring returns the plunger to the resting position automatically when the user releases the pad-space. The hand-pump is typically secured to the container via a female-threaded cap with matching male threads incorporated into the container. Multiple hand-pump assemblies having different plunger displacement lengths and diameters can be stored and selected based upon the desired volume of aliquot the user desires to dispense. The hand-pump assemblies typically would have the same threaded cap for securing to the container, so they can be easily interchangeable components with the container. In the continued context of a soil pH adjustment regimen, some plants may need a little more or little less soil pH adjustment and therefore may require slightly more or less of the dilute acid or base aliquot. What is needed in the art is a portable liquid container that can accept a plurality of hand-pump dispensers of similar or differing dispensing volumes to provide a user with more dosing flexibility and control.

The most typical liquids dispensed in the agricultural or horticultural fields are fertilizers and soil pH conditioners, but can include others such as liquid humates, fish oil emulsions and hydrolysates, aqueous ammonia and urea, biostimulants, secondary and micronutrients, pesticides and herbicides. Many of these liquids can be hazardous to the users dispensing them and often require special protections to prevent personnel exposure. Most of these liquids are not very suitable to open containers due to risk of spillage and often are required to be mixed or diluted by the users prior to dispensing. What is needed in the art is a container that can be sufficiently open to allow mixing or dilution in a controlled environment, but then sealable and spill-proof/splash-proof when carried into the crop field for dispensing.

Traditional plastic hand-pump containers are comprised of a single round bottom section that tapers to a threaded central axial opening port at the top of the container. The hand-pump dispenser must be first removed to fill the container and then be re-inserted. The threaded cap of the hand-pump is then tightened around the male threads of the opening port to make ready for use. These type plastic containers most commonly have a small rounded handle that is attached on one end to the round bottom section and on the other to the area just below the male threads of the opening port. For most portable applications, these type containers are limited in the capacity of liquid they can contain due to the maximum comfortable weight a user can support by the few fingers that can be inserted into these relatively small container handles. Finally, placing a carrying handle on the tapered side wall of the container does not facilitate dispensing the liquid while at the same time carrying the container. The force of pressing down on the dispensing plunger add additional force on fingers gripping the handle and an awkward torqueing action must be counter-balanced by the user. What is needed in the art is a container than can carry more than a gallon of the dispensing liquid and have a larger handle that the user can grip firmly with the entire hand and not just a few fingers. What is further needed in the art is a centrally-located hand grip section that can better counter-balance the weight and torque forces placed on the grip when the dispenser plunger is pressed while at the same time the container is being carried.

Another drawback of existing hand-pump containers and pump-sprayers generally is the combining of the inlet port for filling the container with the outlet port for dispensing and spraying. By having to first remove the hand-pump to fill the container, an extra step is required and the risk of contaminating or unwanted release of liquid outside of the container is elevated. What is needed in the art is a hand-pump container that can be refilled without having to remove the hand-pump.

### DESCRIPTION OF FIGURES

FIG. 1—An elevation view of a typical thermoplastic container fitted with a hand-pump dispenser and carrying handle.

FIG. 2—An elevation view of an embodiment of the current invention having two hand-pump dispensers of different discharge volumes per pump stroke located symmetrically atop a common liquid containment compartment, a full-sized hand grip positioned centrally between the pump dispensers, and a separate fill port positioned centrally to container and below the hand grip.

FIG. 3—A 3-dimensional view looking down on to the current invention having two hand-pump dispensers of different discharge volumes per pump stroke located symmetrically around a central fill port placed below a handle interconnecting the two hand-pump dispensers.

FIG. 4—A top down view of an embodiment of the current invention where a third hand-pump and container assembly is added to create a 3-pump container.

FIG. 5—A top down view of an embodiment of the current invention where a fourth hand-pump and container assembly is added to create a 4-pump container. However, in this configuration, the hand-pumps are not in a linear arrangement as in FIG. 4, but rather are in a square arrangement.

### SUMMARY OF THE INVENTION

The present invention is a portable liquid container comprising a plurality of variable volume hand-pump dispensers arranged in different configurations that do not need to be removed to refill the container, and having a wide-body grip handle spanning and attached to the hand-pump dispensers that provide a more secure means for carrying the container.

In another embodiment of the invention, the container has a plurality of hand-pumps dispensing different volumes per plunger stroke that draw from a common liquid storage volume below that has a separate fill port. In another embodiment of the invention, the container has internal baffling that separates the liquids being dispensed by the hand-pumps. In another embodiment, the liquid container is made from an inert thermoplastic material of sufficient opacity to allow the liquid level in the container to be observed and a plurality of external markings that allow the user to readily assess the volume of liquid remaining within the container.

In another embodiment of the invention, the container has a centrally-located void section and tapering at the base of the container to direct residual liquids toward the hand-pump suction tubes. d two hand-pump dispensers of variable dispensing volume that draw from two separate liquid compartments below that share a common dividing wall and each have a separate fill port.

### DETAILED DESCRIPTION

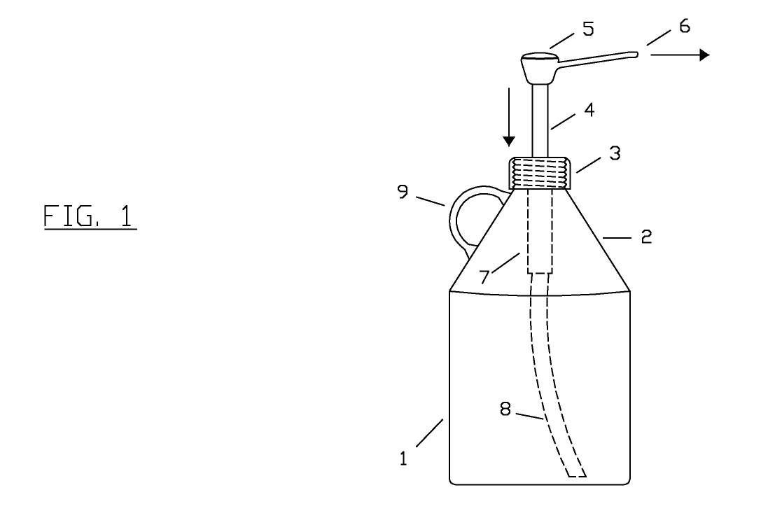

In reference to FIG. 1, a typical thermoplastic container for liquids is shown having a lower section 1 of a constant diameter and a converging upper section 2 that tapers the container's walls from the diameter of the lower section to the diameter of a threaded fill port 3. A single hand-pump dispenser is inserted into the threaded fill port 3 after the liquid is filled into the container. The hand-pump dispenser is comprised of a flexible suction tube 8, a liquid storage volume 7, a plunger shaft 4, a plunger head 5 and a discharge spout 6. On to the outer surface of the converging upper section 2, a looping handle 9 extends outward from the container that is used to support the container during movement. To discharge a fixed-quantity of the liquid out of the container, the user typically places the container onto a rigid surface and presses down on the plunger head 5. The pressing force cause the plunger shaft to compress the liquid storage volume 7, which in turn forces the liquid up and out through the discharge spout 6. When the pressing force is ceased, a spring located within the liquid storage volume 7, returns the plunger head to the fully extended height and refills the liquid storage volume by drawing a new aliquot of liquid into the plunger storage volume 7 up through the flexible suction tune 8. Typically, the container must be placed on a rigid surface when dispensing because the rigid surface provides the resistance force that allows the plunger head to be pressed downward without causing the container to move at the same time. Alternatively, the user can provide this resistance force by grasping the container handle 9 while pressing down on the plunger head. This allows the container to be moving while dispensing should the user desire. However, for most containers, mobility during dispensing is limited because the user will have to both support the weight of the liquid in the container and the pressing force during dispensing. Often, the container handle 9 only allows the user to insert a few fingers, which greatly limits the comfortable support weight the user can tolerate when carrying the container and especially when attempting to dispense the liquid at the same time as carrying the container.

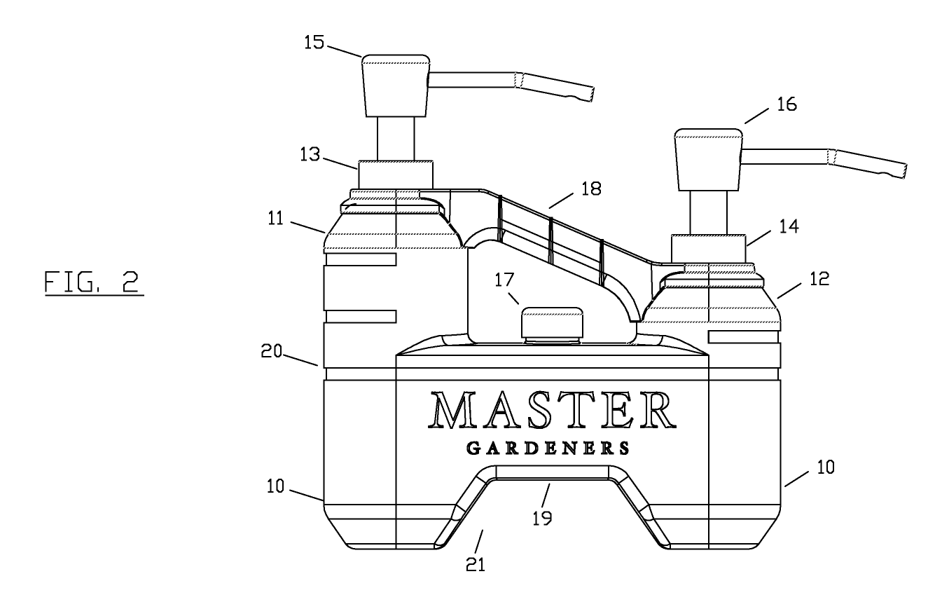

In reference to FIG. 2, a container of the current invention is shown that is comprised of a plurality of rounded, rigid lower sections 10 and plurality of converging upper sections 11 and 12 that taper the container's walls from the diameter of the lower section to the diameters of two threaded pump ports 13 and 14. In the embodiment of FIG. 2, the two hand-pumps 15 and 16 dispense differing amounts of the container's liquid when actuated. In other embodiments, the hand-pumps can be of equal discharge volumes when actuated. In the embodiment of FIG. 2, hand-pump 16 dispenses a larger volume than hand-pump 15. The two rounded lower sections of the container walls are joined together by a rectangular-shaped extension tank 19 and a carrying handle 18. This extension tank provides for additional liquid storage volume over a single dispensing container of FIG. 1. The extension tank 19 has a common fill port 15 that allows the container to be filled and re-filled with liquid without requiring removal of either of the hand-pump dispenser assemblies. This feature is often preferred, especially when the liquid inside the container is toxic or corrosive. Liquid residues often coat the surfaces of the dispenser assemblies that reside inside the container and might have to be cleaned each time they are removed from the container. By not having the container's fill port also be the hand-pump dispenser's insertion port, the hand-pump dispenser does not have to be removed during refilling.

In continued reference to FIG. 2, a reinforced handle 18 extends above the common fill port 15 and adjoins the converging upper sections 11 and 12. Since the containers hand-pumps are spaced apart, a broader grip handle 16 is provided compared to the looping handle 9 of FIG. 1. Instead of the user only being able to support the container with a few fingers, the whole hand of the user can grasp the handle, which allows for a larger container liquid volume to be carried comfortably and securely. Also, because the handle 16 extends over the center of gravity of the container, the weight of the container is more balanced at the handle when carried compared to a single-dispenser container (see FIG. 1).

In one embodiment, the common fill port 15 is comprised of a male-threaded protrusion extending upwards from the top center of rectangular extension tank 19 and a similarly threaded female cap that is tightened after charging liquid to the container. In another embodiment, the common fill port 15 is comprised of an uncapped check valve that allows liquid to be readily added to the container while preventing liquid from exiting the container back out through the common fill port. In another embodiment, the rectangular extension tank has a central internal baffle that prevents liquid in one side of the container from mixing with the liquid on the other side of the container. In one version of this embodiment, a capped fill port or check valve is placed on either side of the internal baffle of the rectangular extension tank so that each liquid compartment can be filled separately. In another version of this embodiment, a single, slightly enlarged fill port is centrally located above the internal baffle so that the separate containers can be filled by directing the liquid to either side of the baffle. In one embodiment, the check valve is comprised of one or more flaps with springs that force the flaps to close in the default state but allow the flaps to open when a slight downward force is applied. This embodiment is particularly useful when filling the container from a small diameter tube connected to a fill pump. The weight of the fill tube opens the flap of the check valve to allow the liquid to enter the container. The flap automatically closes when the fill tube is removed.

In continued reference to the embodiment of FIG. 2, the container is fabricated from a thermoplastic material of sufficient opacity that the level of the liquid within the container can be observed. In another embodiment, the container material is sufficiently opaque to prevent viewing the liquid from outside the container, except for a notched band 20 that has reduced opacity to allow the liquid level to be viewed. The notched band 20 provides the user with a line of fill-markation around the entire container to assess the “full” condition during filling through the common fill port 17. In one embodiment, the rectangular-shaped extension tank 19 is internally baffled to provide separate compartments from which the hand-pumps dispense the container's contents. In one embodiment with internal baffling, the common fill-port 17 may be omitted to allow the headspace above the common lower sections 10 to hold additional liquid volume. In this embodiment, the liquids would be filled through the hand-pump dispenser nozzles 13 and 14 after the hand-pumps are removed.

In continued reference to FIG. 2, a void 21 is removed from the extension tank 19. At low liquid levels within the container, the void 21 causes the container's liquid contents to pool underneath the hand pumps where the flexible suction tubes extend. Pooling the liquid below the suction tubes maximizes the amount of liquid that can be pumped from the container. The void may also be useful for stabilizing the container across a raised plant row. The stability of the container is enhanced by allowing the raised plant row soil to occupy the container void 21 while the lower container sections 10 occupy the space on either side of the plant row. The void 21 does not affect the stability of the container when placed on generally flat surfaces as the lower container sections 10 are flat-bottomed. Since the volume displaced by the void 21 also displaces a volume of liquid that can be stored inside the container, sizing the void 21 is a balance based on the most common surface conditions farmers or horticulturists experience in the field. In one embodiment, the dimensions of the void 21 are approximately 6 in. width, 6 in. length and 2.5 in. height, but only displaces around 4/10 of a gallon of liquid storage volume. In other embodiments, the void 21 may be omitted altogether to allow more liquid to be stored in the container.

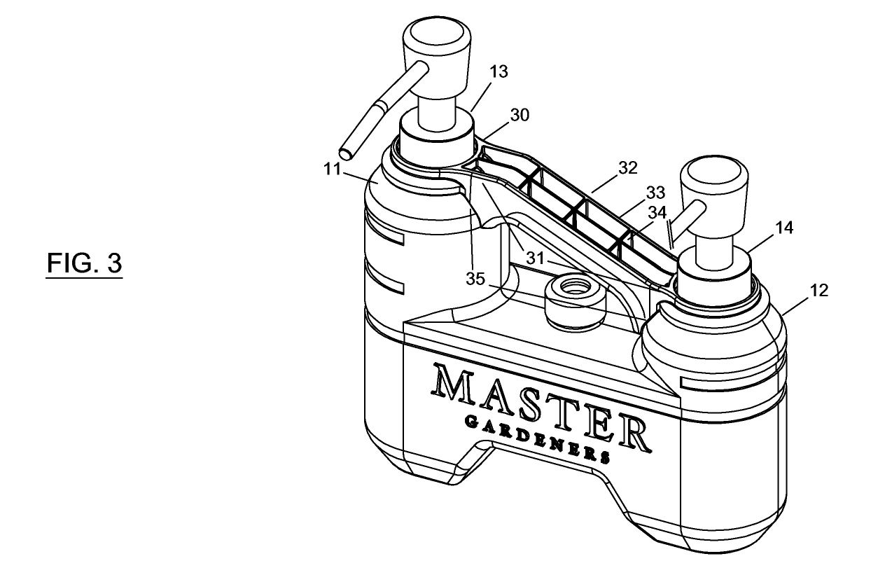

In reference to FIG. 3, the two ends of the rectangular handle attach to the threaded pump ports 13 and 14 at the base of the threaded nuts that secure the pump assemblies to the container. In one embodiment, the handle is comprised of two ends rings 30 and 34 that are placed around the threaded pump ports and bound against the container when the threaded nuts of the hand-pump dispensers are tightened against the container ports. In this embodiment, the handle can be removed to enhance access to the common fill port 17 by removing the hand-pump dispensers and lifting the handle and end rings up and away from the container. In other embodiments, the handle can be permanently molded into the outer surfaces of the upper container sections or can be secured to them by a plurality of small fasteners.

In continued reference to FIG. 3, the rectangular handle is further comprised of two short horizontal section 31 that extend away from outer surface of each base of the hand-pump dispensers, and a rectangular extension section 32 that connects to the horizontal sections. In embodiments where the two hand-pumps dispense different liquid volumes, and the upper converging sections 13 and 14 are of differing heights extending above the common container base section 10, the rectangular extension section 32 will be slightly angled relative to the horizontal. In embodiments where the two hand-pumps dispense equal volumes, and the upper container sections are of equal height, rectangular extension section 32 will be substantially horizontal. In one embodiment, the rectangular handle is comprised of a plurality of thin extension members 33 that are secured together using a plurality of cross ribs 34 placed perpendicular to the thin extension members to provide maximum rigidity of the handle while using a lesser amount of handle material. One skilled in the art of making handles from different materials will understand the balance between material cost, methods of reinforcing and strength of design, and methods of attaching the handle to the carried subject.

In continued reference to the rectangular extension handle of FIG. 3, the underside of the straight sections 31 engage the outer surfaces of the converging upper sections 11 and 12 at points 35. By engaging the outer surface of the converging upper sections, the weight forces subjected to the handle may be better distributed to the container itself and not just the threaded hand-pump ports at 13 and 14.

In the embodiment of FIG. 3, the center-to-center distance between the two hand-pump assemblies is 127 mm. The inside width of the rectangular extension tank is 55.3 mm and the height between the “max-fill” line and the base of the extension tank is 81.9 mm. The “max-fill” line is 71.7 mm above the bottom of the lower container sections 10. The inner diameter of the two container sections below the hand-pumps is also 55.3 mm. Using these dimensions, the formula for computing the approximate working volume of the container is as follows:

Vₘₐₓ=V_{HP1}+V_{HP2}+V_{ET}

V_{HP1}=V_{HP2}=π*D_{CT}²/4*H_{CT}

V_{ET}=L_{ET}*W_{ET}*H_{ET}

W_{ET}=C_{-TO-}C−D_{CT}

Vₘₐₓ=2*π*D_{CT}²/4*H_{CT}+L_{ET}*(C_{-TO-}C−D_{CT})*W_{ET}*H_{ET}

Vₘₐₓ=2*π*(55.3²/4)*44.45*(127−55.3)*55.3*44.45=570 mL

V_{working}=Vₘₐₓ*(1−12%)=570 mL*88%=^{˜}500 mL
Actual working volume is reduced by approximately 12% due to overlap in calculating the volume of the rectangular extension tank and the volumes of the two container sections below the hand pumps. Also, the working volume is further reduced slightly due to tapering of the lower container sections 10 at the bases.
   One skilled in the art would understand that a container with more or less working liquid volume can be created by scaling and adjusting these internal spacing dimensions or modifying the formulas to fit a given configuration of the components described herein.

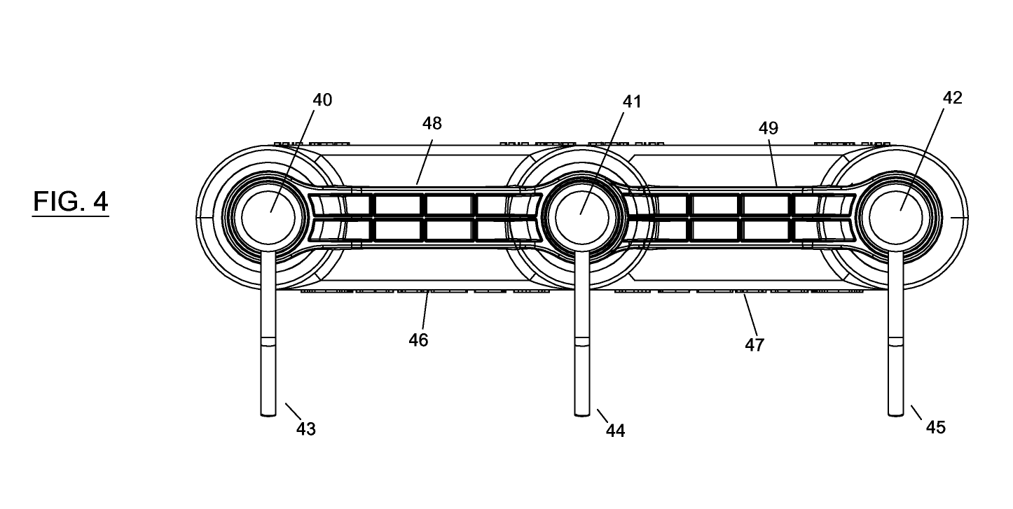

In reference to FIG. 4, an embodiment of the current invention is shown where the plurality of hand-pumps connected to the container is three. Hand-pump dispensers 40, 41, and 42 may be of equal dispensing volumes when actuated or of differing dispensing volume to provide the user with increased flexibility in selecting the best amount of liquid to dispense in the field. The 360-degree, rotatable dispensing tips 43, 44, and 45 may be identical in length, angle of dispersion and liquid discharge velocity. Alternatively, one or more of the dispensing tips could have differing lengths, angles of dispersion and discharge velocities to further increase the flexibility of the invention to the user in the field. A pair of gripping handles 48 and 49 span in opposite directions out from the central hand-pump 41 to each of the other hand-pump assemblies 40 and 42. In one embodiment, the gripping handles 48 and 49 are level when the container is placed on a flat surface. In another embodiment, the central hand-pump assembly 41 is of a differing height relative to the other two hand-pump assemblies 40 and 42, which causes the gripping handles to be angled relative to the horizontal when the container is placed on a flat surface. By adding the third hand-pump assembly (40 or 42), the container's carrying volume is essentially doubled by the addition of a second rectangular extension tank (46 or 47) extending from the central hand-pump assembly 41. In the embodiment of FIG. 4, void sections are removed from the underside of the two rectangular extension tanks 46 and 47 to cause the liquid in the container to pool at low volume levels underneath the hand-pump assemblies to maximize the amount of dispensable liquid. The embodiment of FIG. 4 arranges the three hand-pump assemblies linearly and requires only two reinforced grip-handles. However, in another embodiment, the three hand-pump assemblies are arranged in a triangular configuration, with three reinforced hand-grips spanning each of the hand-pump assemblies.

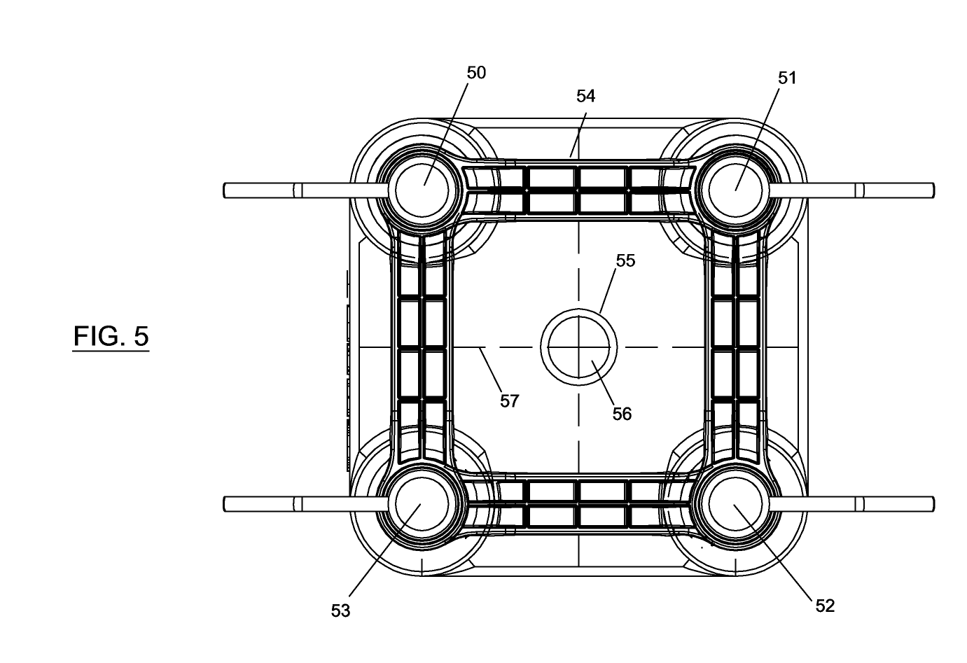

In reference to FIG. 5, an embodiment of the current invention is shown where instead of combining multiple hand-pump assemblies in a linear arrangement as in FIG. 4, four hand-pump assemblies are arranged in a square to provide a portable, multi-dispensing container. The four hand-pumps 50, 51, 52, and 53 form a roughly square-sided container. A plurality of reinforced handles 54 also form a square around the central fill port 55. In one embodiment of FIG. 5, the central fill port 55 is comprised of four check-valve flaps 56 that provide quick-access infill ports. In one embodiment of FIG. 5, internal baffles 57 form four separate compartments under each hand-pump where different liquids can be contained and prevented from mixing. In another embodiment of FIG. 5, no internal baffles are used so that all of the hand-pump have access to the same liquid within the container. The square-shaped arrangement of the reinforced grip handles 54 between each of the four hand-pump assemblies provides both a structural reinforcement of the container as a whole, but also provides multiple points of engagement when carrying the container.

Differing embodiments of this invention are described herein. Variations of those embodiments may become apparent to those having ordinary skill in the art upon reading this specification. The inventors expect that skilled artisans will employ such variations as appropriate, and the inventors intend for the invention to be practiced other than as specifically described herein. Accordingly, this invention includes all modifications and equivalents of the subject matter recited in the claims appended hereto as permitted by applicable law. Moreover, any combination of the above-described elements in all possible variations hereof is encompassed by the invention unless otherwise indicated herein or otherwise clearly contradicted by context.

While the disclosure above sets forth the principles of the present invention, with the examples given for illustration only, one should realize that the use of the present invention includes all usual variations, adaptations and/or modifications. within the scope of the claims attached as well as equivalents thereof. Those skilled in the art will appreciate from the foregoing that various adaptations and modifications of the just described embodiments can be configured without departing from the scope and spirit of the invention. Therefore, it is to be understood that, within the scope of the appended claims, the invention may be practiced other than as specifically described herein.

What is claimed for Letters Patent is:

1. A portable container for dispensing a liquid comprising:
a lower containment compartment with a centrally-located fill port,
a pair of upper containment compartments extending above the lower compartment and converging to a threaded port for receiving a hand-pump having a suction end that extends into the liquid contents and a discharge end outside of the portable container, and
a reinforced grip handle having ends secured to each of the threaded ports of the upper containment compartments and spanning over the centrally-located fill port.

2. The portable container of claim 1, wherein the lower containment compartment has an internal baffle such that the liquids being dispensed from each of the hand-pumps are separated and do not mix.

3. The portable container of claim 1 wherein the centrally-located fill port is comprised of a male-threaded opening and a female-threaded cap that is secured to the lower containment compartment after filling.

4. The portable container of claim 1 wherein the centrally-located fill port is comprised of an automatically reseating check valve that allows liquid to flow into the lower containment compartment but prevents liquids from flowing back out of the lower compartment.

5. The portable container of claim 2 wherein the centrally-located fill port is comprised of two automatically reseating check valves that allow liquid to flow into each of the two lower compartments but prevents liquid from flowing back out of the two lower compartments.

6. The portable container of claim 1 further comprising a centrally-located void space located within the lower compartment such that residual liquid is directed toward the suction ends of the hand-pumps.

7. The portable container of claim 1 further comprising a horizontal band extending around the lower compartment having a reduced opacity such that the liquid level inside the lower compartment can be viewed from outside the container during filling.

8. The portable container of claim 1 wherein the grip handle is removable and is secured to the upper containment compartments when the threaded hand-pump assemblies are tightened.

9. The portable container of claim 1 wherein the reinforced handle grip is secured to the upper containment compartments using a plurality of fasteners.

10. A portable container for dispensing a liquid comprising:
a lower containment compartment with a centrally-located fill port,
a plurality of upper containment compartments extending above the lower compartment and converging to a threaded port for receiving a hand-pump having a suction end that extends into the liquid contents and a discharge end outside of the portable container, and
a plurality of reinforced grip handles having ends secured to each of the threaded ports of the upper containment compartments and spanning over the centrally-located fill port.

11. The portable container of claim 10 wherein the plurality of upper containment compartments are arranged linearly over the lower containment compartment.

12. The portable container of claim 10 wherein the plurality of upper containment compartment is three and arranged triangularly over the lower containment compartment.

13. The portable container of claim 10 wherein the plurality of upper containment compartments is four and arranged squarely over the lower containment compartment.
